(19) United States
(12) Patent Application Publication
(10) Pub. No.: US 2008/0300930 A1
(43) Pub. Date: Dec. 4, 2008

(54) DEVELOPING AND STRUCTURING BUSINESS ECOSYSTEMS

(76) Inventors: Michael J. Compitello, Bedford, NH (US); Harold C. Van Hercke, Highlands Ranch, CO (US)

Correspondence Address: HOFFMAN WARNICK LLC, 75 STATE ST, 14TH FLOOR, ALBANY, NY, 12207, US

(21) Appl. No.: 11/755,136

(22) Filed: May 30, 2007

(51) Int. Cl. G06F 15/00; G06F 9/44; G06F 17/50

(52) U.S. Cl. 705/7

(57) ABSTRACT

This present invention structures and implements a process for alliance development using an ecosystem of partners around a defined solution framework. Under the present invention, the solution framework is first defined, and then an ecosystem is developed to strengthen and implement the solution (and the portfolio of offerings available within the solution area). As such, a solution provider will define a framework for a particular opportunity, and then identify a set (at least one) of solution partner to help fulfill the framework. Collectively, the solution provider and solution partner(s) function collectively within the ecosystem to capitalize on the opportunity.

### FIELD OF THE INVENTION

The present invention generally, relates to solution frameworks. Specifically, the present invention relates to alliance development processes for an ecosystem model.

### BACKGROUND OF THE INVENTION

Business alliances are often formed as an approach to a particular opportunity. Traditionally, such alliances involved a solution provider having to contract with multiple independent solution partners in order to capitalize on a business opportunity. Existing approaches required isolation among the multiple business partners. That is, individual alliance relationships were built with no informal or formal collaboration for the specific solution space. Moreover, individual geographies utilized various alliances based on local relationships, rather than a solution framework agreed upon globally. Each geography, therefore, had to separately endorse a specific relationship after the global team initiated the base relationship. Alliance partners also expected the solution provider to build a pipeline around their specific products or technology, rather than around a broader provider-centric solution framework. Still yet, the traditional approach required competition with every other integrators and business partners that sold that particular alliance partner's solution with little differentiation. This tended to focus sales on narrow problem areas rather than on a broad solution involving multiple partners and provider brands. As such, alliance partners did not view themselves as part of a portfolio to deliver a solution, but rather a niche play to establish and maximize their own channel relationships.

In view of the foregoing, there exists a need for a solution that addresses at least one of the above-referenced deficiencies in the related art.

### SUMMARY OF THE INVENTION

This present invention structures and implements a process for alliance development using an ecosystem of partners around a defined solution framework. Under the present invention, the solution framework (hereinafter “framework”) is first defined, and then an ecosystem is developed to strengthen and implement the solution (and the portfolio of offerings available within the solution area). As such, a solution provider (hereinafter “provider”) will define a framework for a particular opportunity, and then identify a set (at least one) of solution partners (hereinafter “partner(s)”) to help fulfill the framework. Collectively, the provider and partner(s) function collectively within the ecosystem to capitalize on the opportunity.

Along these lines, an “end-to-end” framework that positions the provider as the “thought leader” is defined. Then, due diligence of current and relevant components that are provider-acquired or developed is performed. This will allow a gap analysis of provider-owned competencies against the “end-to-end” framework to be performed. A strategy for filling the gaps is then developed. This can include deciding whether build vs. buy vs. identify partner(s) to fill any gaps. Where partners are determined to be needed, an evaluation current partners and required future partners will be performed based on defined criteria such as functional capability, etc. This will allow each partner to be defined as primary, alternative, or secondary. Each partner identified will then be classified/positioned as being (for example): (1) key to the ecosystem; (2) supportive/emerging; or (3) opportunistic/convenience-based partners. The effectiveness of each partner will also be evaluated based on their geography, and alternative partner(s) will be utilized where required. Thereafter, a center can be implemented for accelerated global implementation of sales support and global application of the “end-to-end” value proposition/framework.

A first aspect of the present invention provides a method for developing a structuring a business ecosystem, comprising: defining a solution framework for a business opportunity; performing due diligence of current and relevant components that originate from the solution provider; performing a gap analysis of components that originate from the solution provider against the solution framework; identifying a set of solution partners to fill any gaps identified by the gap analysis; evaluating each of the set of solution partners based on defined criteria; positioning each of the set of solution partners based on their importance to the ecosystem; determining an effectiveness of each of the set of solution partners based on geography; and developing and structuring the business ecosystem based on the evaluating, positioning, and the determining to best fulfill the solution framework.

A second aspect of the present invention provides a system for developing a structuring a business ecosystem, comprising: a module for defining a solution framework for a business opportunity; performing due diligence of current and relevant components that originate from the solution provider; a module for performing a gap analysis of components that originate from the solution provider against the solution framework; a module for identifying a set of solution partners to fill any gaps identified by the gap analysis; a module for evaluating each of the set of solution partners based on defined criteria; a module for positioning each of the set of solution partners based on their importance to the ecosystem; a module for determining an effectiveness of each of the set of solution partners based on geography; and a module for developing and structuring the business ecosystem using the solution provider and the set of solution partners to best fulfill the solution framework.

A third aspect of the present invention provides a program product stored on a computer readable medium for developing a structuring a business ecosystem, the computer readable medium comprising program code for causing a computer system to: define a solution framework for a business opportunity; perform due diligence of current and relevant components that originate from the solution provider; perform a gap analysis of components that originate from the solution provider against the solution framework; identify a set of solution partners to fill any gaps identified by the gap analysis; evaluate each of the set of solution partners based on defined criteria; position each of the set of solution partners based on their importance to the ecosystem; determine an effectiveness of each of the set of solution partners based on geography; and develop and structure the business ecosystem using the solution provider and the set solution partners to best fulfill the solution framework.

A fourth aspect of the present invention provides computer software embodied in a computer readable medium for developing a structuring a business ecosystem, the computer software comprising instructions for causing a computer system to: define a solution framework for a business opportunity; perform due diligence of current and relevant components that originate from the solution provider; perform a gap analysis of components that originate from the solution provider against the solution framework; identify a set of solution partners to fill any gaps identified by the gap analysis; evaluate each of the set of solution partners based on defined criteria; position each of the set of solution partners based on their importance to the ecosystem; determine an effectiveness of each of the set of solution partners based on geography; and develop and structure the business ecosystem using the solution provider and the set solution partners to best fulfill the solution framework.

A fifth aspect of the present invention provides a method for developing a structuring a business ecosystem, comprising: providing a computer infrastructure being operable to define a solution framework for a business opportunity; perform due diligence of current and relevant components that originate from the solution provider; perform a gap analysis of components that originate from the solution provider against the solution framework; identify a set of solution partners to fill any gaps identified by the gap analysis; evaluate each of the set of solution partners based on defined criteria; position each of the set of solution partners based on their importance to the ecosystem; determine an effectiveness of each of the set of solution partners based on geography; and develop and structure the business ecosystem using the solution provider and the set solution partners to best fulfill the solution framework.

A sixth aspect of the present invention provides a computer-implemented business method for developing a structuring a business ecosystem, comprising: defining a solution framework for a business opportunity; performing due diligence of current and relevant components that originate from the solution provider; performing a gap analysis of components that originate from the solution provider against the solution framework; identifying a set of solution partners to fill any gaps identified by the gap analysis; evaluating each of the set of solution partners based on defined criteria; positioning each of the set of solution partners based on their importance to the ecosystem; determining an effectiveness of each of the set of solution partners based on geography; and developing and structuring the business ecosystem based on the evaluating, positioning, and the determining to best fulfill the solution framework.

For each of these aspects at least one of the following additional aspects can be provided. A center for implementing and supporting the business ecosystem can be deployed. The defined criteria can comprise a capability of each of the set of solution partners, a priority of each of the set of solution partners relative to one another, and a competitive relationship of each of the set of solution partners with one another. The capability can be selected from a group consisting of full, partial and none. The priority can be selected from a group consisting primary, alternative and secondary. The competitive relationship can be selected from a group consisting competitive and complimentary. The positioning can comprise determining an importance of each of the set of solution to the ecosystem. The importance can be selected from a group consisting of key, emerging, and opportunistic. Negotiations with each of the solution partners to be part of the business ecosystem can be held. The aspects can be based on a set of workshops. Graphical output can be generated based on the set of workshops.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a view of a traditional business alliance versus a business ecosystem according to the present invention.

FIG. 2 depicts a view of a development process according to the present invention.

FIG. 3 depicts a view of a solution framework as interlocked with a business ecosystem according to the present invention.

FIG. 4 depicts a view of solution partners as evaluated based to predefined criteria according to the present invention.

FIG. 5 depicts a view of solution partners as positioned based on their importance to the business ecosystem according to predefined criteria according to the present invention.

FIG. 6 depicts a view of an integrated solution based on customer technology decisions according to the present invention.

FIG. 7 depicts a view of a business ecosystem as optimized by geographic region according to the present invention.

FIG. 8 depicts a view of solution partners being mapped based on geographic region according to the present invention.

FIG. 9 depicts a more specific computerized implementation according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Computerized Implementation

### I. General Description

As used herein, the term “solution provider” refers to a party who develops a master solution framework for achieving a business opportunity and/or capitalizing on a business opportunity. The term “solution partner” refers to a party retained, contracted, utilized by a solution provider to fulfill the solution framework. In a typical embodiment, a solution partner is used to provide goods and/or services called for in a solution framework that a solution provider cannot and/or will not provide.

Regardless, as indicated above, the present invention structures and implements a process for alliance development using an ecosystem of partners around a defined solution framework. Under the present invention, the solution framework (hereinafter “framework”) is first defined, and then an ecosystem is developed to strengthen and implement the solution (and the portfolio of offerings available within the solution area). As such, a solution provider (hereinafter “provider”) will define a framework for a particular opportunity, and then identify a set (at least one) of solution partners (hereinafter “partner(s)”) to help fulfill the framework. Collectively, the provider and partner(s) function collectively within the ecosystem to capitalize on the opportunity.

Along these lines, an “end-to-end” framework that positions the provider as the “thought leader” is defined. Then, due diligence of current and relevant components that are provider-acquired or developed is performed. This will allow a gap analysis of provider-owned competencies against the “end-to-end” framework to be performed. A strategy for filling the gaps is then developed. This can include deciding whether build vs. buy vs. identify partner(s) to fill any gaps. Where partners are determined to be needed, an evaluation current partners and required future partners will be performed based on defined criteria such as functional capability, importance to the ecosystem, competitive relationship with one another, geography, etc. This will allow each partner to be defined as primary, alternative, or secondary. Each partner identified will then be classified/positioned as being (for example): (1) key to the ecosystem; (2) supportive/emerging; or (3) opportunistic/convenience-based partners. The effectiveness of each partner will also be evaluated based on their geography, and alternative partner(s) will be utilized where required. Thereafter, a center can be implemented for accelerated global implementation of sales support and global application of the “end-to-end” value proposition/framework.

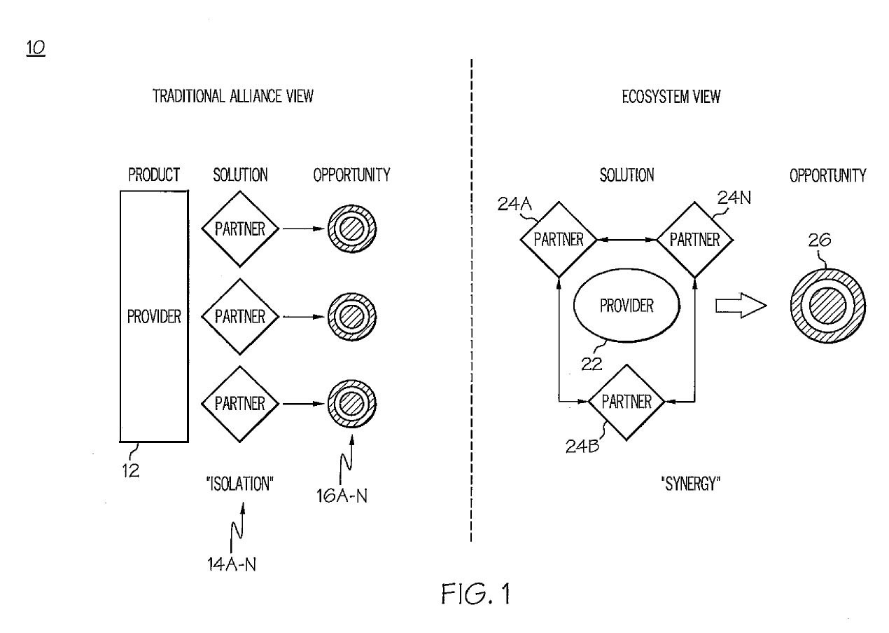

Referring now to the Figs. The present invention will be described in greater detail. Specifically, referring to FIG. 1, a view of a traditional business alliance versus a business ecosystem according to the present invention is shown. Specifically, view 10 shows a traditional alliance view. As shown, a solution provider 12 retains/collaborates with a set (at least one) of solution partners 14A-N to capitalize on a set of opportunities 16A-N. Along these lines solution partners 14A-N exists and work separate and apart from one another at different opportunities 16A-N. Conversely, as shown in view 20, the present invention develops a synergy among solution provider 20 and solution partners 24A-N to capitalize on a single business opportunity. As will be further described below, this is accomplished via a set of workshops that are used to: formulate a master solution framework that positions the solution provider as the leader or thoughts leader; select, evaluate, and position appropriate solution partners to form a business ecosystem 20 (such as that shown in FIG. 1); and support and implement the solution framework.

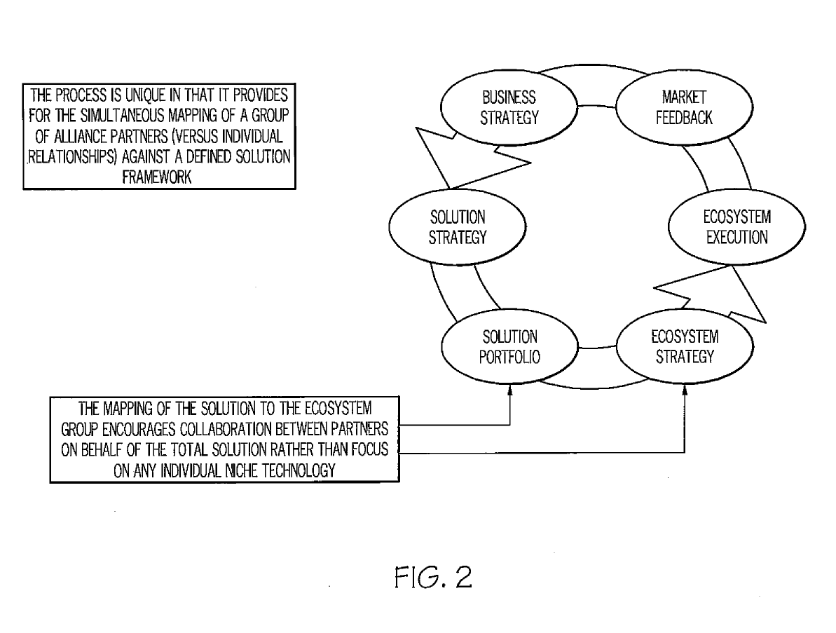

FIG. 2 depicts a view of a development process according to the present invention. As can be seen, the present invention involves a simultaneous mapping (not previously taught) of several concepts. These include ecosystem strategy, ecosystem execution, marketplace feedback, business strategy, solution strategy, and solution portfolio. This mapping encourages collaboration among partners on behalf of the total provider solution rather than their focus on their own niche technology.

In general, when a business opportunity arises, the solution provider will first define a solution framework for capitalizing on the opportunity and that positions the solution provider as the leader or thoughts leader. This can involve identify tasks that need to be complete, goods and/or services that need to be obtained and/or provided, business objected that need to be fulfilled, etc. Referring now to FIG. 3, an illustrative solution framework 30 is shown. As depicted, solution framework 30 shows various components 32 (e.g., Governance, Privacy, Threat Mitigation, etc.) that will go into capitalizing on the opportunity.

Once the components are so identified, solution provider will perform due diligence of current and relevant components 32 that originate from the solution provider (e.g., ones that the solution provider will has or will create). Thereafter, a gap analysis of components that originate from the solution provider will be performed against solution framework 30. This will identify any gaps in what solution provider is capable of providing against what is needed for solution framework 30. For example, a gap can be identified if the solution provider is not capable of providing the governance component of FIG. 3. A gap can also be identified where solution provider is cannot provide a component in a manner that means or exceeds a certain minimum standard (e.g., quality, expense, time frame, etc.).

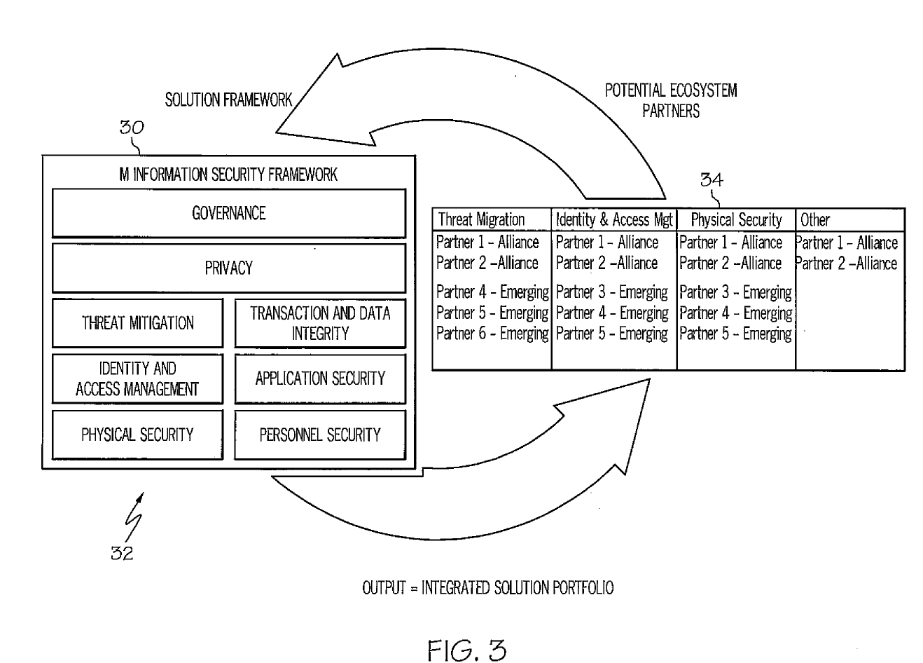

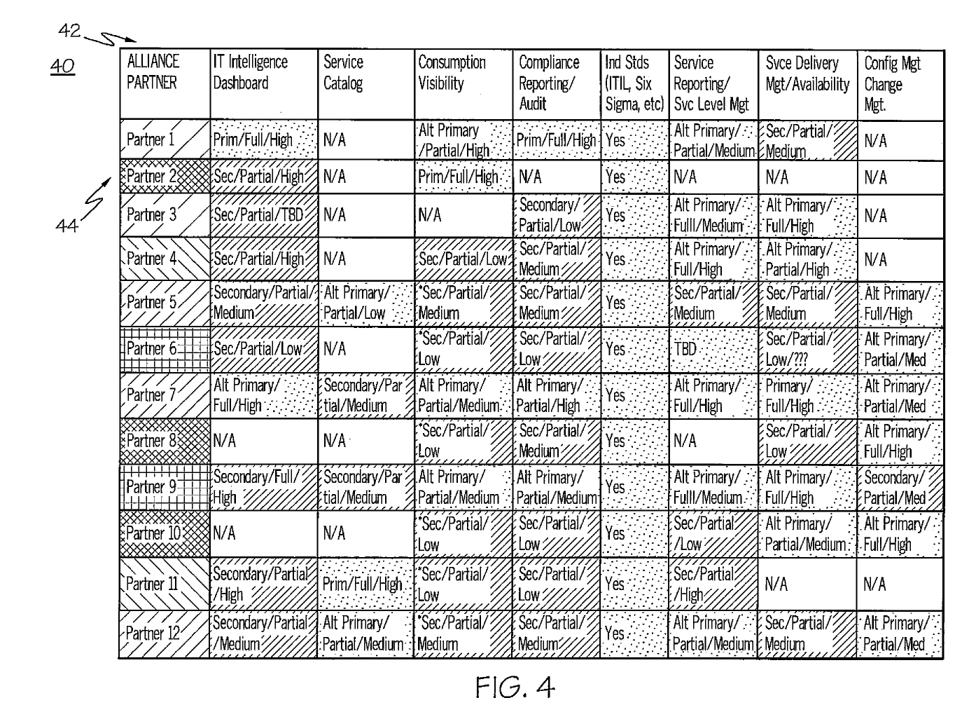

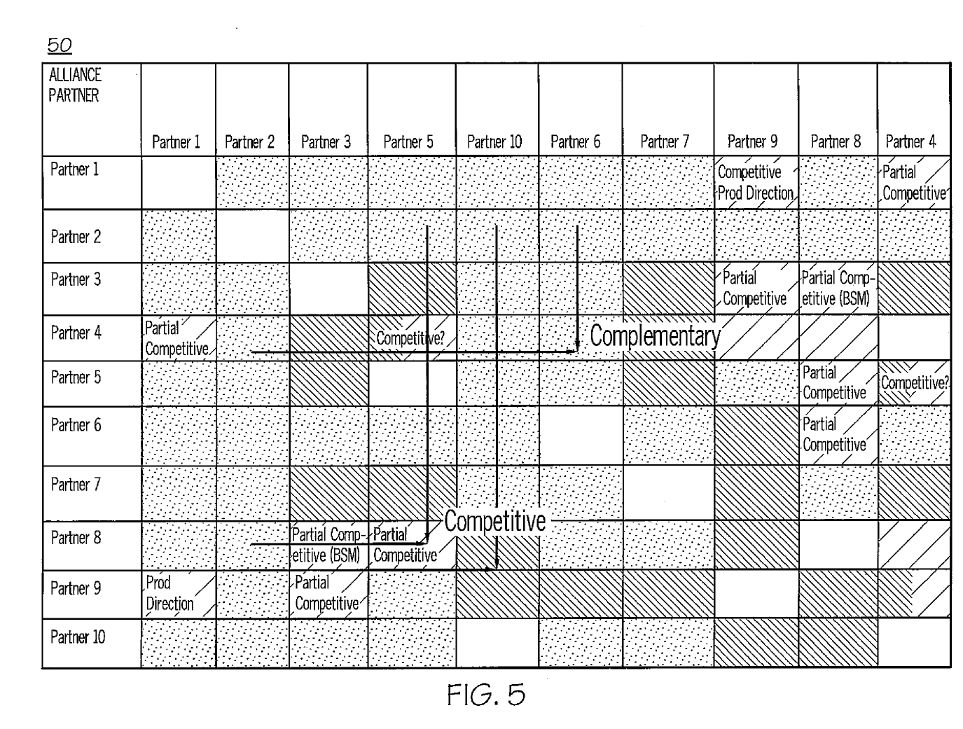

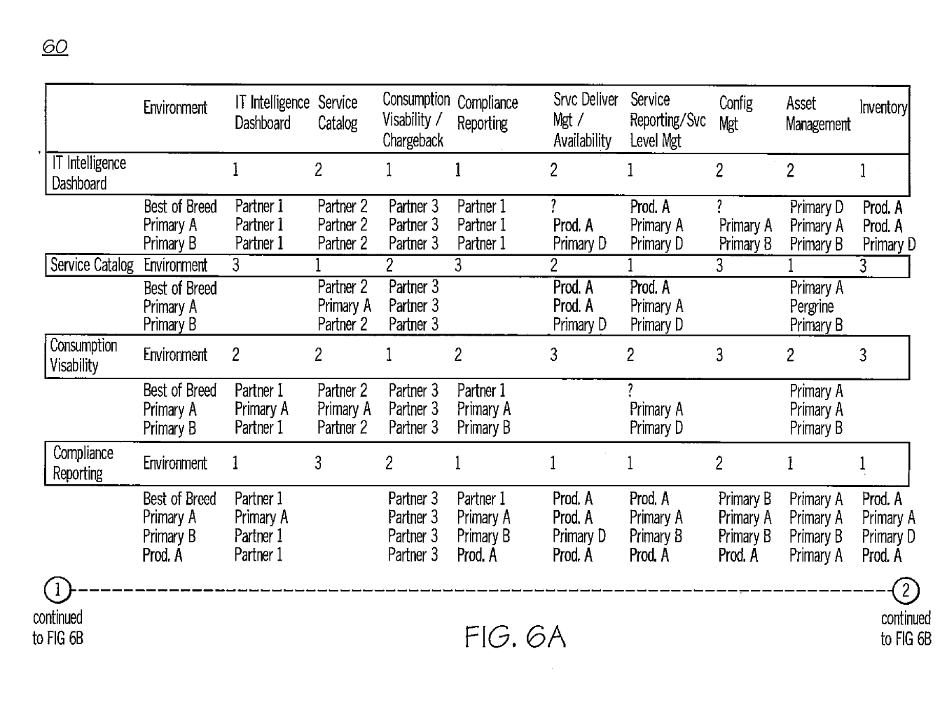

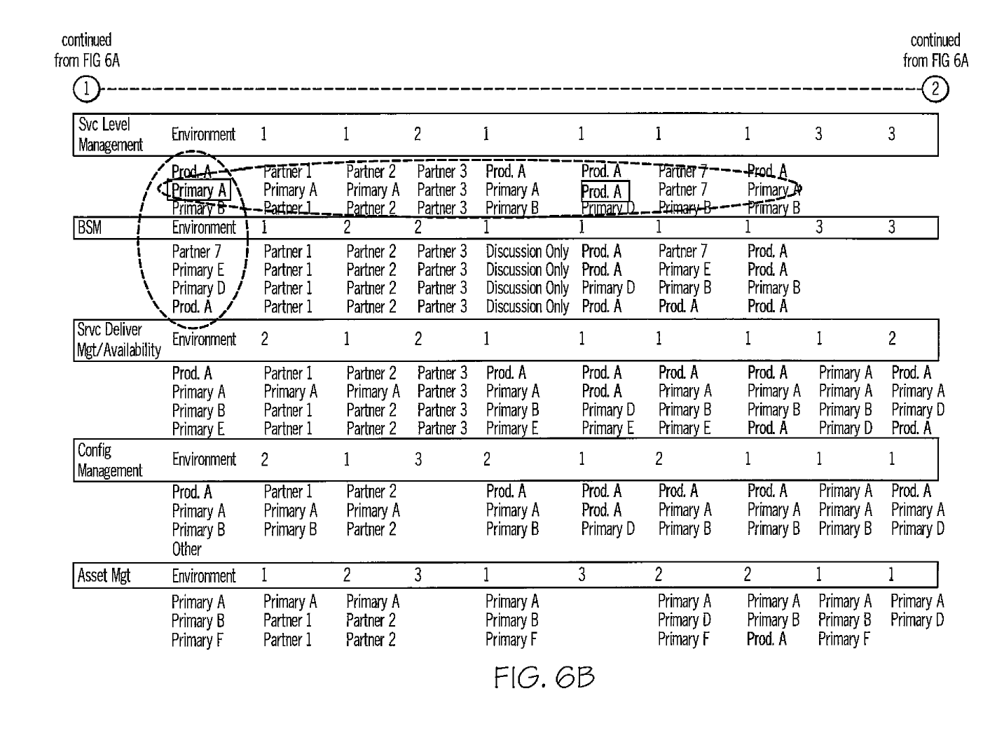

Thereafter, a set of solution partners will be identified to fill any gaps identified by the gap analysis. As shown, in chart 34, solution partners 1-6 have been identified to help fulfill the solution framework. Once identified, the set of solution partners will then go through one or more rounds of evaluation, positioning and/or geography-based effectiveness determination. For example, each of the set of solution partners will be evaluated based on defined criteria. The defined criteria can comprise: a capability (full, partial, or none) of each of the set of solution partners, a priority (primary, alternate, or secondary) of each of the set of solution partners relative to one another, and a competitive relationship (competitive or complimentary) of each of the set of solution partners with one another. Examples of this are shown in FIGS. 4-6. Specifically, FIG. 4 shows an illustrative mapping 40 of components 42 of a solution framework to solution partners 44. Mapping 40 also depicts illustrative evaluation results in the intervening cells. For example, solution partner 1 is indicating as having a primary priority and being fully competent providing the “IT Intelligence Dashboard” component. FIG. 5 shows a mapping 50 illustrative the competitive relationship among solution partners. For example, solution partner 1 is deemed to have a competitive relationship with solution partner 9 where product direction is concerned. FIG. 6 shows a mapping 60 of an integrated solution based on customer technology decisions to allow for cross-selling. For example, where the “IT Intelligence Dashboard” component intersects with the “Service Reporting/Service Level Management” component, a customer technology decision to use “product A” is shown.

Along similar lines, an effectiveness/capability (high, medium, low, etc.) of each of the set of solution partners based on their geography can also be performed. These results are depicted in FIG. 4 where solution partner 1 was indicated as being highly capable/effective of providing the “IT Intelligence Dashboard” component. It should be understood that this capability/effectiveness determination could be made in conjunction with the evaluation of the solution partners based on define criteria as discussed above in conjunction with FIG. 4.

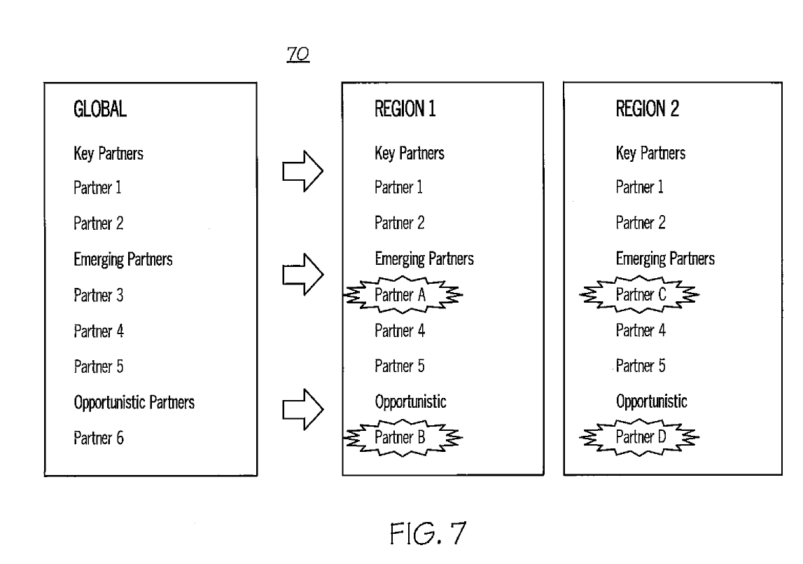

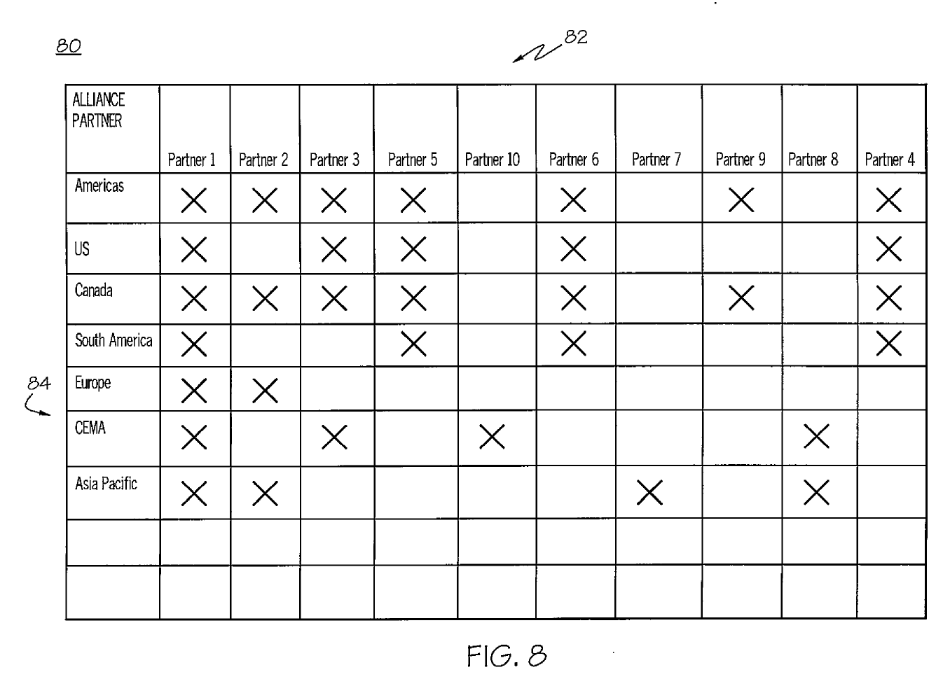

In any event, also under the present invention, each of the set of solution partners will be positioned based on their importance (hey, emerging, or opportunistic) to the ecosystem. This is shown in mapping 70 of FIG. 7 and can be based on geographic region. For example, for “Region 1”, key solution partners are indicated as being solution partners 1 and 2. FIG. 8 further more specific mapping 80 of solution partners 82 to geographic regions 84. This helps foster understanding of the business ecosystem deployment variations and successes.

Once the solution partners have been fully analyzed the business ecosystem can be developed and structured based thereon to best fulfill the solution framework. This can involve negotiating with each of the solution partners to be part of the business ecosystem. In addition, a center (e.g., Center of Excellence or CoE) for implementing and supporting the business ecosystem can be deployed and maintained. The CoE accelerates the sales process by leveraging best practices, providing global thought leadership, providing a method for rapid training of delivery resources, shortening the proposal development cycle, increasing solution provider brand content, increasing win rate on complex proposals, leveraging existing IP, and providing greater opportunity for IP monetization.

As indicated above, the present invention is typically implemented pursuant to a set of workshops whereby output (e.g., graphical) such as that depicted in the Figs. Regardless, the ecosystem approach discussed herein also provides a great deal of benefit to the alliance partner including leveraging IBM brands, positioning and promotion of partners and their products within the solution provider, providing a single point of contact and advocate into the solution provider's complex organizations, providing early traction for engagement opportunities, and best practices for alliance management and success.

Along these lines, the ecosystem approach to alliance development: links a solution area and business strategy with the solution partners chosen; results in global agreement on specific partners to use in that solution space; gives the alliance partners a clear understanding of their position within the solution provider's solution framework; provides consistent global business modeling for a client to implement a combined provider/multi-partner strategy within the solution space; eliminates the disparate sales execution strategies that included various partners depending on local relationships; enhances our relationship with partners who now view themselves as part of a solution portfolio, rather than a niche player; differentiates the solution provider from other systems integrators; and allows the solution provider to go to market faster and more efficiently.

### II. Computerized Implementation

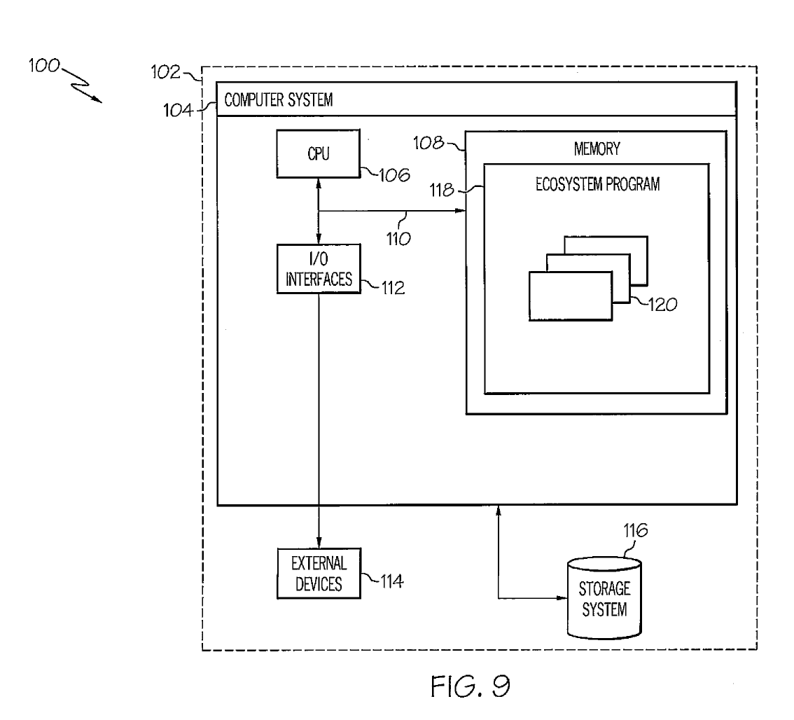

Referring now to FIG. 9, a computerized implementation 100 of the present invention is shown. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

As shown, computer system 104 includes a processing unit 106, a memory 108, a bus 110, and input/output (I/O) interfaces 112. Further, computer system 104 is shown in communication with external I/O devices/resources 114 and storage system 116. In general, processing unit 106 executes computer program code, such as ecosystem program 118, which is stored in memory 108 and/or storage system 116. While executing computer program code, processing unit 106 can read and/or write data to/from memory 108, storage system 116, and/or I/O interfaces 112. Bus 110 provides a communication link between each of the components in computer system 104. External devices 114 can comprise any devices (e.g., keyboard, pointing device, display, etc.) that enable a user to interact with computer system 104 and/or any devices (e.g., network card, modem, etc.) that enable computer system 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, I/O interfaces 112 can comprise any module for exchanging information with one or more external device 1 14. Still further, it is understood that one or more additional components (e.g., system software, math co-processing unit, etc.) not shown in FIG. 9 can be included in computer system 104. However, if computer system 104 comprises a handheld device or the like, it is understood that one or more external devices 114 (e.g., a display) and/or storage system 116 could be contained within computer system 104, not externally as shown.

Storage system 116 can be any type of system capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104.

Shown in memory 108 of computer system 104 is ecosystem program 118, which a set (at least one) of modules 120. The modules generally provide the functions of the present invention as described herein. Specifically (among other things), set of modules 120 is configured to: help define, an “end-to-end” framework that positions the solution provider as the leader or thoughts leader.; aid the performance of due diligence of current and relevant components that are provider-acquired or developed; aid the performance of a gap analysis of provider-owned competencies against the “end-to-end” framework to be performed; and produce a strategy for filling the gaps is then developed. This can include deciding whether build vs. buy vs. identify partner(s) to fill any gaps. Where partners are determined to be needed, set of modules 120 can aid evaluation of current partners and required future partners to be performed based on defined criteria. Set of modules 120 can also be used to classify/position set of solution providers as being (for example): (1) key to the ecosystem; (2) supportive/emerging; or (3) opportunistic/convenience-based partners. The effectiveness of each solution partner will also be evaluated based on their geography, and alternative partner(s) will be utilized where required. Thereafter, a center can be implemented for accelerated global implementation of sales support and global application of the “end-to-end” value proposition/framework.

While shown and described herein as a method, system, and program product for developing and structuring businesses ecosystems, it is understood that the invention further provides various alternative embodiments. For example, in one embodiment, the invention provides a computer-readable/useable medium that includes computer program code to enable a computer infrastructure to develop and structure businesses ecosystems. To this extent, the computer-readable/useable medium includes program code that implements each of the various process of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 9) and/or storage system 116 (FIG. 9) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to develop and structure businesses ecosystems. In this case, the service provider can create, maintain, support, etc., a computer infrastructure, such as computer infrastructure 102 (FIG. 9) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for developing and structuring businesses ecosystems. In this case, a computer infrastructure, such as computer infrastructure 102 (FIG. 9), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 104 (FIG. 9), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for developing a structuring a business ecosystem, comprising:
defining a solution framework for a business opportunity;
performing due diligence of current and relevant components that originate from the solution provider;
performing a gap analysis of components that originate from the solution provider against the solution framework;
identifying a set of solution partners to fill any gaps identified by the gap analysis;
evaluating each of the set of solution partners based on defined criteria;
positioning each of the set of solution partners based on their importance to the ecosystem;
determining an effectiveness of each of the set of solution partners based on geography; and
developing and structuring the business ecosystem based on the evaluating, positioning, and the determining to best fulfill the solution framework.

2. The method of claim 1, further comprising deploying a center for implementing and supporting the business ecosystem.

3. The method of claim 1, the defined criteria comprising a capability of each of the set of solution partners, a priority of each of the set of solution partners relative to one another, and a competitive relationship of each of the set of solution partners with one another.

4. The method of claim 3, the capability being selected from a group consisting of full, partial and none, the priority being selected from a group consisting primary, alternative and secondary, and the competitive relationship relative being selected from a group consisting competitive and complimentary.

5. The method of claim 1, the positioning comprising determining an importance of each of the set of solution to the ecosystem, the importance being selected from a group consisting of key, emerging, and opportunistic.

6. The method of claim 1, further comprising negotiating with each of the solution partners to be part of the business ecosystem.

7. The method of claim 1, the method being based on a set of workshops.

8. The method of claim 7, further comprising generating graphical output based on the set of workshops.

9. A system for developing a structuring a business ecosystem, comprising:
a module for defining a solution framework for a business opportunity;
performing due diligence of current and relevant components that originate from the solution provider;
a module for performing a gap analysis of components that originate from the solution provider against the solution framework;
a module for identifying a set of solution partners to fill any gaps identified by the gap analysis;
a module for evaluating each of the set of solution partners based on defined criteria;
a module for positioning each of the set of solution partners based on their importance to the ecosystem;
a module for determining an effectiveness of each of the set of solution partners based on geography; and
a module for developing and structuring the business ecosystem using the solution provider and the set of solution partners to best fulfill the solution framework.

10. The system of claim 9, further comprising a module for deploying a center for implementing and supporting the business ecosystem.

11. The system of claim 9, the defined criteria comprising a capability of each of the set of solution partners, a priority of each of the set of solution partners relative to one another, and a competitive relationship of each of the set of solution partners with one another.

12. The system of claim 11, the capability being selected from a group consisting of full, partial and none, the priority being selected from a group consisting primary, alternative and secondary, and the competitive relationship relative being selected from a group consisting competitive and complimentary.

13. The system of claim 9, the module for positioning being configured to determine an importance of each of the set of solution to the ecosystem, the importance being selected from a group consisting of key, emerging, and opportunistic.

14. The system of claim 9, further comprising a module for supporting negotiations with each of the solution partners to be part of the business ecosystem.

15. A program product stored on a computer readable medium for developing a structuring a business ecosystem, the computer readable medium comprising program code for causing a computer system to:
define a solution framework for a business opportunity;
perform due diligence of current and relevant components that originate from the solution provider;
perform a gap analysis of components that originate from the solution provider against the solution framework;
identify a set of solution partners to fill any gaps identified by the gap analysis;
evaluate each of the set of solution partners based on defined criteria;
position each of the set of solution partners based on their importance to the ecosystem;
determine an effectiveness of each of the set of solution partners based on geography; and
develop and structure the business ecosystem using the solution provider and the set solution partners to best fulfill the solution framework.

16. The program product of claim 14, the computer readable medium further comprising program code for causing the computer system to deploy a center for implementing and supporting the business ecosystem.

17. The program product of claim 14, the defined criteria comprising a capability of each of the set of solution partners, a priority of each of the set of solution partners relative to one another, and a competitive relationship of each of the set of solution partners with one another.

18. The program product of claim 17, the capability being selected from a group consisting of full, partial and none, the priority being selected from a group consisting primary, alternative and secondary, and the competitive relationship relative being selected from a group consisting competitive and complimentary.

19. The program product of claim 15, the computer readable medium further comprising program code for causing the computer system to determine an importance of each of the set of solution to the ecosystem, the importance being selected from a group consisting of key, emerging, and opportunistic.

20. The program product of claim 15, the computer readable medium further comprising program code for causing the computer system to negotiate with each of the solution partners to be part of the business ecosystem.
